(19) United States
(12) Patent Application Publication
(10) Pub. No.: US 2010/0332604 A1
(43) Pub. Date: Dec. 30, 2010

(54) MESSAGE SELECTOR-CHAINING

(75) Inventors: Sujeet Mishra, Bangalore (IN); Ruchir Jha, Philadelphia, PA (US); Lohitashwa Thyagaraj, Bangalore (IN)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/494,915

(22) Filed: Jun. 30, 2009

(51) Int. Cl. G06F 15/16

(52) U.S. Cl. 709/206

(57) ABSTRACT

Methods, systems, and computer program products for selecting messages in an enterprise computing environment are described herein. In one embodiment, a method is provided for selecting one or more of a multitude of messages in an enterprise computing environment. The method comprises forming a message-selector chain from a plurality of message selectors, each of the message selectors identifying at least one criteria, and using said message-selector chain to select one or more of said multitude of messages that satisfy the message selector chain. In this embodiment, using said message-selector chain to select one or more of said multitude of messages includes identifying a first of the multitude of messages that satisfies a first of the message selectors, and selecting one or more of the multitude of messages that has a defined relationship to said first of the messages and that satisfies a second of the message selectors.

### TRADEMARKS

IBM® is a registered trademark of International Business Machines Corporation, Armonk, N.Y., U.S.A. Other names used herein may be registered trademarks, trademarks or product names of International Business Machines Corporation or other companies. JAVA™ is a trademark of Sun Microsystems.

### BACKGROUND OF THE INVENTION

Messaging is typically a method of communication between software components or applications. A messaging system is a peer-to-peer facility. A messaging client can send messages to, and receive messages from, any other clients. Each client typically connects to a messaging agent that provides facilities for creating, sending, receiving, and reading messages.

Messaging enables distributed communication that is loosely coupled. A component sends a message to a destination, and the recipient can retrieve the message from the destination. However, the sender and the receiver do not have to be available at the same time in order to communicate. In fact, the sender does not need to know anything about the receiver; nor does the receiver need to know anything about the sender. The sender and the receiver need to know only what message format and destination to use. In this respect, messaging differs from tightly coupled technologies, such as remote method invocation (RMI), which requires an application to know a remote application's method.

The Java message service (JMS) is a Java API that allows applications to create, send, receive, and read messages. Designed by Sun Microsystems and other partners, the JMS API defines a common set of interfaces and associated semantics that allow programs written in the Java programming language to communicate with other messaging implementations. A typical JMS application may include a JMS provider, one or more JMS clients, messages, one or more administered objects, and one or more native clients. A JMS provider is a messaging system that implements the JMS interfaces and provides administrative and control features. JMS clients are the programs or components, written in the Java programming language, that produce and consume messages. Messages are the objects that communicate information between the JMS clients. Administered objects are preconfigured JMS objects created by an administrator for the use of clients. There are two kinds of administered objects: destinations and connection factories. Native clients are programs that use a messaging product's native client API instead of the JMS API. An application first created before the JMS API became available and subsequently modified is likely to include both JMS and native clients.

Typically, most current implementations of the JMS API provide support for both point-to-point (PTP) and the publish/subscribe (pub/sub) domains. A PTP product or application is built around the concept of message queues, senders, and receivers. Each message is addressed to a specific queue, and receiving clients extract messages from the queue(s) established to hold their messages. Queues retain all messages sent to them until the messages are consumed or until the messages expire. Under a PTP system, each message has only one consumer. A sender and a receiver of a message have no timing dependencies. The receiver can fetch the message whether or not it was running when the client sent the message. The receiver acknowledges the successful processing of a message. FIG. 1A is a block diagram illustrating an example of a PTP messaging configuration.

In a publish/subscribe (pub/sub) product or application, clients address messages to a topic. Publishers and subscribers are generally anonymous and may dynamically publish or subscribe to the content hierarchy. The system takes care of distributing the messages arriving from a topic's multiple publishers or its multiple subscribers. Topics retain messages only as long as it takes to distribute them to current subscribers. Under a pub/sub system, each message may have multiple consumers (also referred to as subscribers). Publishers and subscribers have a timing dependency. As a general rule, a client that subscribes to a topic can consume only messages published after the client has created a subscription, and the subscriber must continue to be active in order for the subscriber to consume messages.

In addition, the JMS APT relaxes this timing dependency to some extent by allowing clients to create durable subscriptions. Durable subscriptions can receive messages sent while the subscribers are not active. Durable subscriptions provide the flexibility and reliability of queues but still allow clients to send messages to many recipients. FIGS. 8A and 8B (described in greater detail below) are block diagrams illustrating examples of a durable subscription versus a non-durable subscription in an enterprise messaging system.

JMS messages maybe consumed synchronously or asynchronously. Under the synchronous model, a subscriber or a receiver explicitly fetches the message from the destination by calling the “receive” method. The “receive” method can block until a message arrives or can time out if a message does not arrive within a specified time limit. Under the asynchronous model, a client can register a message listener with a consumer. A message listener is similar to an event listener. Whenever a message arrives at the destination, the JMS provider delivers the message by calling the listener's “on Message” method, which acts on the contents of the message.

FIG. 1C is a block diagram illustrating a typical object-oriented enterprise messaging system, such as a Java message system (JMS). Referring to FIG. 1C, two parts of a JMS application, destination and connection factories, are best maintained administratively rather than programmatically. These components are implemented as objects under object-oriented programming environments, particularly referred to as administered objects. The technology underlying these objects is likely to be very different from one implementation of the JMS API to another. Thus, the management of these objects varies from provider to provider.

JMS clients access these objects through interfaces that are portable, so a client application can run with little or no change on more than one implementation of the JMS API. Ordinarily, an administrator configures administered objects in a Java naming and directory interface (JNDI) API namespace, and JMS clients then look them up, using the INDI API. For example, in a J2EE (Java 2 enterprise edition) development environment, an administrator may use a tool called j2eeadmin to perform the administrative tasks.

A connection factory is the object a client uses to create a connection with a message provider (e.g., a JMS provider). A connection factory may be created using the j2eeadmin tool for a PTP and/or a pub/sub domains. A connection factory encapsulates a set of connection configuration parameters that has been defined by an administrator.

A destination is the object a client uses to specify the target of messages it produces and the source of messages it consumes. In a PTP messaging domain, destinations are referred to as queues, while in a pub/sub domain, the destinations are referred to as topics. A JMS application may use multiple queues and topics.

A connection encapsulates a virtual connection with a JMS provider. A connection could represent an open TCP/IP socket between a client and a provider server's daemon. A connection may be used to create one or more sessions. When an application completes, any connections associated with the application have to be closed. Failure to close a connection can cause resources not to be released by the JMS provider. Closing a connection also closes its session and their message producers and message consumers. A session is a single-breaded context for producing and consuming messages. Sessions may be used to create message producers, message consumers, and messages.

A message producer is an object created by a session and is used for sending messages to a destination. A message consumer is an object created by a session and is used to receive messages sent to a destination. A message consumer allows a JMS client to register interest in a destination with a JMS provider. The JMS provider manages the delivery of messages from a destination to the registered consumers of the destination. Once a consumer is created, it becomes active and may be used to receive messages. A consumer may be closed via a “close” method. A message listener is an object that acts as an asynchronous event handler for messages. A message listener is not specific to a particular destination type. The same message listener may obtain messages from either a queue or a topic, depending on whether the listener is set for a queue receiver or a topic subscriber.

If a messaging application needs to filter the messages it receives, a JMS API message selector may be used to specify the messages a consumer is interested in. Message selectors assign the work of filtering messages to the JMS provider rather than to the application. A message selector is a string that contains an expression. The syntax of the expression is based on a subset of the conditional expression syntax according to a specification, such as SQL92 specification. The message consumer then receives only messages whose headers and properties match the selector. Typically, a message selector cannot select messages on the basis of the content of the message body.

The ultimate purpose of a JMS application is to produce and to consume messages that can then be used by other software applications. JMS messages have a basic format that is simple but highly flexible, allowing a user to create messages that match formats used by non-JMS applications on heterogeneous platforms. A typical JMS message includes a message header, one or more optional message properties, and an optional message body.

A JMS header typically contains a number of predefined fields that contain values that both clients and providers use to identify and to route messages. For example, every message has a unique identifier, a destination, and other fields, such as a timestamp and a priority level.

Message properties may used to set values in addition to those defined in the message header. For example, the message properties may be used to provide compatibility with other messaging systems, or alternatively, to create message selectors. There are several message body formats (also referred to as message types) defined by JMS API, which allow a user to send and to receive data in many different forms and provide compatibility with existing messaging formats.

As indicated above, the JMS message selector is used to determine which messages the message-driven bean receives. The value is a string that is used to select a subset of the available messages. The syntax is based on a subset of the SQL 92 conditional expression syntax, as described in the JMS specification. The selector string can refer to fields in the JMS message header and fields in the message properties.

The problem with this approach comes when a user wants to select a message based on the properties of other messages also present in the queue. For example, if a user wants to select a message whose (COLOR=RED AND SIZE=SMALL) which should lie between a message with the property (COLOR=BLUE AND SIZE=SMALL) and a message with the property (COLOR=BLUE AND SIZE=LARGE), the user would not be able to form a simple single selector which can browse for the required message. This happens primarily due to the application of a selector only on a single message and the absence of a concept of selector-chaining across multiple messages

### BRIEF SUMMARY

Methods, systems, and computer program products for selecting messages in an enterprise computing environment are described herein. In one embodiment, a method is provided for selecting one or more of a multitude of messages in an enterprise computing environment. The method comprises forming a message-selector chain from a plurality of message selectors, each of the message selectors identifying at least one criteria, and using said message-selector chain to select one or more of said multitude of messages that satisfy the message selector chain. In this embodiment, using said message-selector chain to select one or more of said multitude of messages includes identifying a first of the multitude of messages that satisfies a first of the message selectors, and selecting one or more of the multitude of messages that has a defined relationship to said first of the messages and that satisfies a second of the message selectors.

In one embodiment, the method further comprises retrieving one or more of the multitude of messages that have a further defined relationship with the message-selector chain. Also, in an embodiment, the multitude of messages are arranged in a defined order, and the selecting one or more of the messages includes selecting one or more of the multitude of messages that have a given position in said order relative to the first of the messages.

### BRIEF DESCRIPTION OF THE SEVERAL VIEWS OF THE DRAWINGS

Embodiments of the invention are illustrated by way of example and not limitation in the figures of the accompanying drawings.

FIG. 1 is a block diagram illustrating an exemplary enterprise application system in which the present invention may be embodied.

FIG. 2 is a block diagram illustrating an exemplary enterprise messaging system in which the present invention may be embodied.

FIG. 3 shows a series of messages in a queue, and a table that lists several message selectors.

FIG. 4 shows a second series of messages in a queue, and a table that lists several message selector-chains.

FIG. 5 illustrates a selector chain match algorithm according to an embodiment of the invention.

FIG. 6 illustrates an example application of selector-chaining according to an embodiment of the invention.

### DETAILED DESCRIPTION

As will be appreciated by one skilled in the art, the disclosure may be embodied as a system, method or computer program product. Accordingly, the disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium, upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the AIC” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

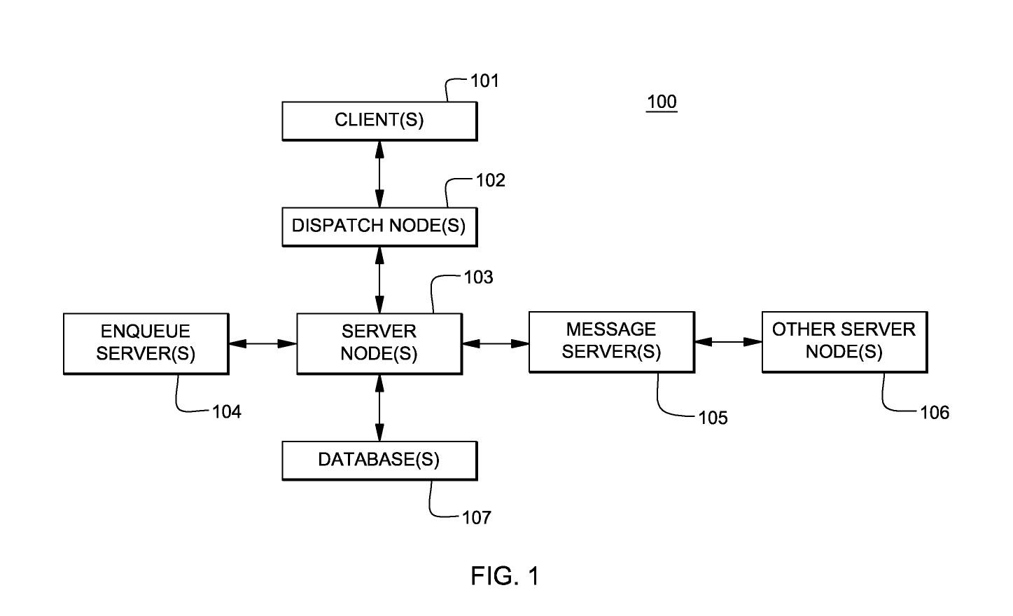

FIG. 1 is a block diagram illustrating an exemplary enterprise application system. For the purpose of illustration, the embodiments of the present application may be illustrated in view of Java computing environment. However, it will be appreciated that other enterprise development environments, such as, for example, the NET framework development environment from Microsoft, may be applied without departing from the broader spirit and scope of embodiments of the invention.

In one embodiment, the exemplary system 200 includes, but is not limited to, one or more client nodes 201, one or more dispatch nodes 202, one or more server nodes 203, an enqueue server 204, a message server 205, database 207, and other server nodes 206. In one embodiment, dispatch node 202 receives a request from client node 201 and sends the request to an appropriate server node 203 via the message server 205. If there is a session already assigned to the respective client, the request is forwarded to the server mapped to the respective session. Otherwise, an appropriate server is chosen using an algorithm for load balancing.

In this embodiment, server node 203 receives the request. During its procession it is possible to access data from the database 207, to set locks into enqueue server 204, or even to send message to other cluster nodes, such as server nodes 206, which may be transmitted over the message server. The database 207 stores most of the system configuration data, binaries and applications. Database 207 supports databases from a variety of vendors, such as, for example, SAP, Oracle, Informix, SQL from Microsoft, DB2 from IBM, etc.

In one embodiment, the communication between the nodes in the system is done using message server 205. Each server node (also referred to as cluster node) may keep a permanently open TCP socket, through which messages are exchanged. The messages may be exchanged using a variety of protocols. The messages may be serialized into a stream of data, which may be communicated within the components of the message server 205. Alternatively, the messages may be serialized into a stream of data that may be transmitted over a variety of communication protocols, such as, for example, the TCP/IP protocol.

In the embodiment of FIG. 1, enqueue server 204 is used to provide a special lock mechanism that synchronizes access to system resources. The purpose of this mechanism is to prevent several threads from accessing a system resource simultaneously. For this purpose the resource may be locked by the thread that will use it. Other components may also be included.

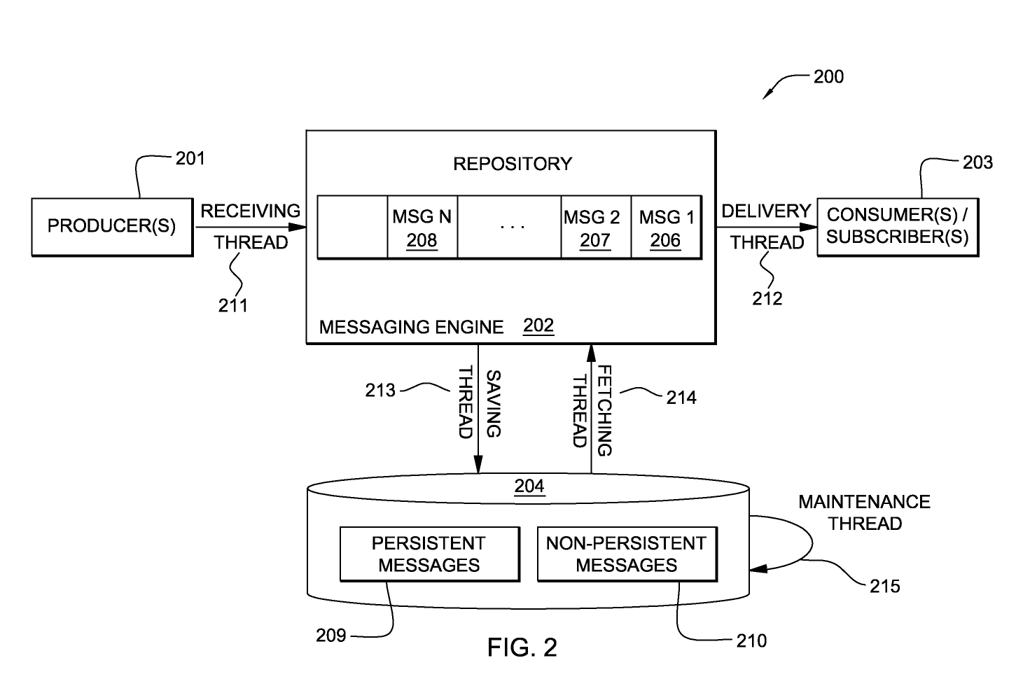

FIG. 2 is a block diagram illustrating an exemplary enterprise messaging system. The exemplary system 300 may be a part of message server 205 of FIG. 1. The exemplary system 300 may be used to process messages generated from a variety of clients, such as, for example, client 201, dispatch node 202, server nodes 204, 203, and 206 of FIG. 1, etc. The exemplary system 300 may also be used to deliver the messages consumed or subscribed to by a variety of clients, such as, for example, client 201, dispatch node 202, server nodes 204, 203, and 206 of FIG. 1, etc.

In one embodiment, the messaging system is a part of the server node. In a particular embodiment, a destination (e.g., a queue or topic) is maintained by a server node. The JMS session for a client may be maintained on another server node. To send messages to the destination, or receive messages from the destination, however, different server nodes may communicate with each other.

The communications between the exemplary system 300 and the clients may be performed via a variety of communication protocols, including a proprietary protocol or a tunneling protocol over a TCP/IP protocol that may be used by a variety of clients including non-Java clients.

According to one embodiment, exemplary system 300 includes, but is not limited to, a messaging engine 302 to receive messages from one or more producers 301 and deliver the messages to one or more consumers in a PTP environment or subscribers in a pub/sub domain. A client may be both a producer to generate one or more messages and a consumer or subscriber to consume the messages from other producers. In addition, the exemplary system 300 includes one or more databases 304 to store messages, which may include persistent messages 309 and non-persistent messages 310.

In the embodiment of FIG. 2, messaging engine 302 includes a repository 305, which may be implemented as a part of system memory or a cache memory of the messaging engine 302. The repository 305 may be used to store messages 306-308 received from one or more producers 301 via one or more receiving threads 311. The messages 306-308 may include persistent messages and non-persistent messages. The messages 306-308 may be, for example, the messages in a PTP messaging environment or alternatively, in a pub/sub messaging environment.

The messages 306-308 may be delivered to one or more consumers or subscribers 303 via one or more delivery threads 312. Messages 306-308 may be received from one or more producers via multiple receiving threads, while messages 306-308 may be delivered to one or more consumers/subscribers via a single delivery thread. According to one embodiment, for each message subscribed to by multiple subscribers, the delivery thread 312 loops through a list of subscribers and delivers the respective message to each of the subscribers. Since the messages are received via multiple receiving threads, the delivery of the messages may fall behind the receiving threads and the repository 305 may be filled up before the messages can be delivered to all of the subscribers 303. As result, some of the messages may be swapped into the database 304.

In order to improve the usability of the repository 305 and improve the delivery of the messages to the consumers/subscribers, the receiving threads 311 and the delivery thread 312 may be prioritized, such that an amount of messages received from the one or more producers 301 may be relatively equivalent to an amount of messages delivered to the consumers/subscribers.

The messaging engine 302 may keep track a client buffer of the consumers or subscribers to determine whether the consumer/subscriber can receive a next message. When the size of a message exceeds an available client buffer size of a consumer/subscriber, the messaging engine 302 may communicate with the client (e.g., the consumer/subscriber) to determine the available client buffer size and indicate the size of the next message. Such a communication may be performed using a variety of communication protocols, such as, for example, an internal protocol if within a server cluster or a tunneling protocol over the TCP/IP protocol. Alternatively, the client may periodically notify the messaging engine 302 the available size of the client buffer that can receive additional messages.

Messages 306-308 may include persistent messages and non-persistent messages. The persistent messages require storage that survives a restart of the system. For example, messages subscribed to by a durable subscriber may be persistent messages. Typically, the persistent messages 309 are stored in a database, such as database 304. If the repository 305 has more available space, the persistent messages may also be stored in the repository 305.

In general, the non-persistent messages are stored in repository 305. However, if the available space of the repository 305 drops below a predetermined threshold, at least a portion of the non-persistent messages may be swapped into the database 304 as non-persistent messages 310. Alternatively, if a size of a non-persistent message exceeds a certain threshold (e.g., bigger than a predetermined size), at least a portion of the non-persistent message may also be swapped into the database 304 as non-persistent messages 310. The persistent and non-persistent messages may be stored in the database 304 via a saving thread 313.

According to one embodiment, when some of the messages stored in the repository 305 have been delivered to the consumers/subscribers, additional messages may be fetched from the database 304 and stored in the repository 305. Thus, the repository 305 may act as an extension of database 304 and may be used for fast delivery of messages to the consumers/subscribers. However, the configurations are not limited to those shown in FIG. 2.

As mentioned above, the JMS message selector is used to determine which messages the message-driven bean receives. The value is a string that is used to select a subset of the available messages. The syntax is based on a subset of the SQL 92 conditional expression syntax, as described in the JMS specification. The selector string can refer to fields in the JMS message header and fields in the message properties.

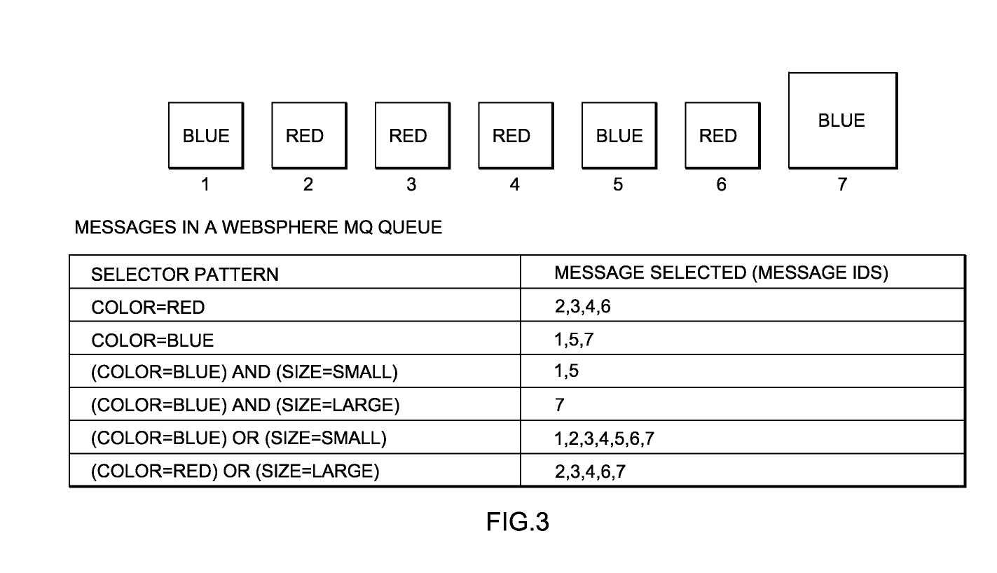

FIG. 3 shows a representative example of existing selector patterns in Websphere MQ, and a table that lists a series of selector patterns and the messages that are selected using each of these patterns. The table clearly illustrates how the selectors can be applied to retrieve messages based on the two example properties of color and size.

The problem with this approach comes when a user wants to select a message based on the properties of other messages also present in the queue. For example, if a user wants to select a message whose (COLOR=RED AND SIZE=SMALL) which should lie between a message with the property (COLOR=BLUE AND SIZE=SMALL) and a message with the property (COLOR=BLUE AND SIZE=LARGE), the user would not be able to form a simple single selector which can browse for the required message. This happens primarily due to the application of a selector only on a single message and the absence of a concept of selector-chaining across multiple messages

The present invention addresses this problem, generally, by chaining together selectors and their application to a message group in order to retrieve a message or group of messages which satisfy the particular selector-chain.

In order to define a selector-chain, a grammar/language is used which the message browser can interpret to return a message or message group which satisfy the conditions in that selector-chain. The language described herein uses a regular expression type construct to define a selector chain.

In the example above, the selector-chain using a regular expression type construct would be:
[SELECTOR-PATTERN1]{Occurrence}+[SELECTOR-PATTERN2]{Occurrence}+[SELECTOR-PATTERN3]{Occurrence][index in the match to be returned]
(COLOR=BLUE AND SIZE=SMALL) (COLOR=RED AND SIZE=SMALL) (COLOR=BLUE AND SIZE=LARGE) [2] Would return the message with id 6 in the message chain in FIG. 3.

If the index position in the match is not specified, then the whole match is returned as a message group.

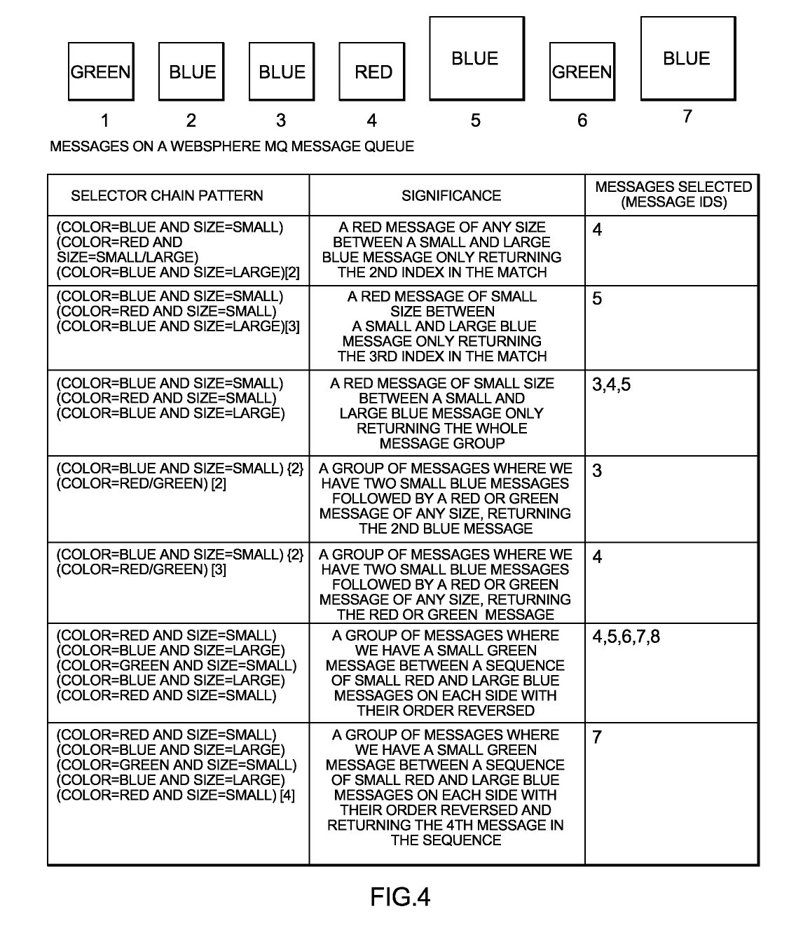

FIG. 4 shows a second example of message patterns, and a table that lists a series of selector patterns and the messages that are selected, in accordance with an embodiment of this invention, using each of these selector patterns. The table clearly shows how selector-chaining can be applied to retrieve messages based on the properties of adjacent messages.

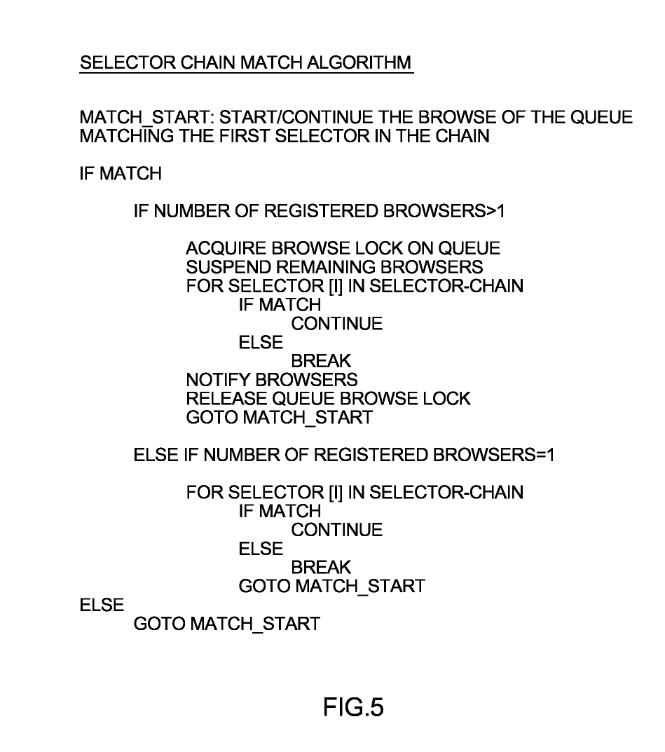

The browser agent on the queue may follow the algorithm of FIG. 5 while matching claimed selectors to messages/message groups.

### Example Application of Selector-Chaining

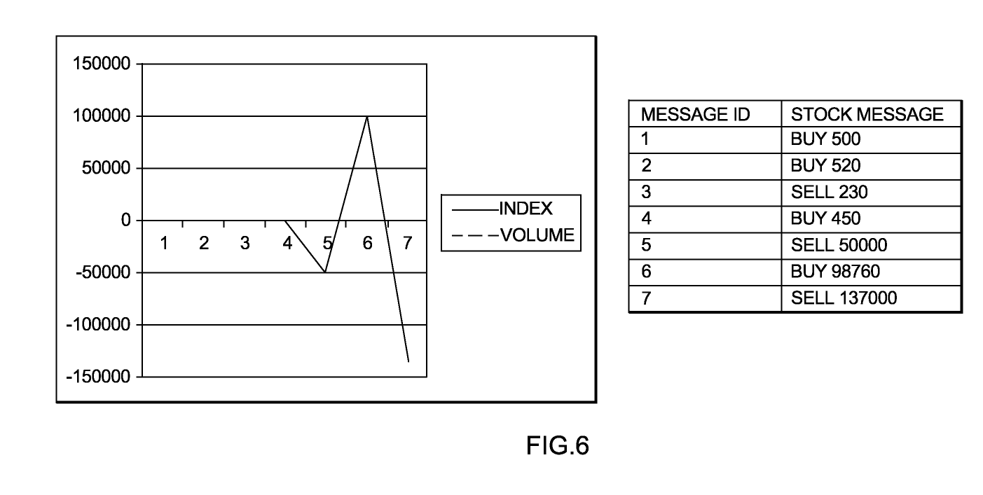

With reference to FIG. 6, a stock quote application sends regular updates in the form of messages to a Message queue. A monitoring application listens on this message queue for volatility spikes. A volatility spike is defined in the company's economic policies as the event of a high volume trading session with huge sell-offs followed by a sequence of massive buying again followed by a large sell off. The monitoring application should suspend trading based on a volatility spike

The two properties set on the Stock Message are TRANSACTION_TYPE and VOLUME

To listen to volatility spikes, the monitoring application applies a selector chain pattern of (TRANSACTION_TYPE=SELL AND VOLUME>50000) (TRANSACTION_TYPE=BUY AND VOLUME>50000) (TRANSACTION_TYPE=SELL AND VOLUME>50000)

The above selector chain would return a message group signifying the volatility spike event. The monitoring application can then proceed to process the event.

The following discussion provides another example of the present invention and a comparison with a database approach.

For any query/rule to be executed with the database approach, a user needs to freeze the state of the queue into a database table and then apply the query on that. The construction of a such an intermediate table where one could apply such a query, is a highly expensive task as compared to a match and proceed rule.

For example, the selector chain pattern may be RBR(a blue message between two Red messages) and a RB message can lie between many green messages as shown below GGGGGGGGGGGGGGGGGGGGGGGGGGGGGGGRBGGGGGGGGGGGGGGGGGGGGGGGGGGGGGGGGG

Using the database approach, the user freezes the whole state of the queue into a table each time and then applies the pattern. So, when the queue-browser starts, it has to construct a table of all the above messages in the queue (which is non deterministic). Now as in the above example we do not have a match, but we still ended up creating a table of elements with all the messages in order to try and apply a full SQL selector chain query on the above message queue.

The approach of the present invention applies the chain only when the first element in the chain succeeds. So the chain will start applying only when the R message is reached. The next element in the chain is matched only if a preceding match succeeds. After the B when the queue-browser reaches a G, it immediately knows that the chain is broken and hence stops the chain match.

The database approach of freezing the state of the queue into a table to apply a query uses a static approach. For example, if we have a queue with messages as GGGGRBGGRG and the match sequence is ROB. Assume the table is created at t0. Meanwhile a message of B arrives on the queue at t0+delta t0. Since the query is being applied on the frozen state of the table, the match is missed, although the queue state has now changed to GGGGRBGGRGB.

With the approach of this invention, the chain is matched as we proceed; let us say the match is started when the queue was GGGGRBGGRG. The B message (GGGGRBGGRGB) can arrive while we are matching the G message in the chain and can be considered for the current chain match.

The database approach will fail for cases when we have messages in the sequence RGBRGBRGBRGB and we apply RGB as the selector chain. In some cases, it will lead to the whole queue being returned as the result set.

With use of regular expressions, we can specify a hungry match or non hungry match to break the chain at the first instance of a RGB or at nth occurrences of a RGB in the chain

The application of a full SQL syntax would result in very complex queries when we match across properties of a single message. The SQL is being applied with the properties of a message as a table with its own right. When we match across properties of a single message in a selector and try and match the other messages, this will result in a M*N result set in match in a table that will be returned, where M is the number of properties being selected in an individual message and N is the number of messages.

For example, a single Selector in the chain can be (COLOR=RED|BLUE|GREEN AND NAME=MATTHEW AND COUNTRY=UK) for the first message in the chain. The second selector can be (COLOR=GREEN AND CITY=LONDON AND SUNNY=YES) A full SQL query would lead to a join or use an intermediate table. This table would contain M×N entries where M is the number of distinct properties and N is the number of Messages.

Columns would be:

| | | | | |
|---|---|---|---|---|
| COLOR | NAME | COUNTRY | CITY | SUNNY |

For messages having possible 100 properties and 100 messages, we would end up creating a table of 100×100 elements.

The present invention matches each selector as it proceeds Hence it takes the step of matching a query (COLOR=RED|BLUE|GREEN AND NAME=MATTHEW AND COUNTRY=UK) on the first message and continues the chain match only when the first match succeeds.

The application of a full SQL syntax would through the intermediate table, fuzzy the position of the message in the chain. We can correctly match the chain but not get the nth element of the chain in that order.

The mechanism of the present invention matches the chain and also provides a mechanism to return a specific message or messages from the chain as obtained in that particular order while matching.

Embodiments of the present invention have significant advantages vs. an approach of a SQL query flowing across messages.

1. Embodiments of the present invention stay within the purview of the JMS specification which says that a selector is used for matching attributes of a message using the SQL 92 syntax.

2. Embodiments of the present invention store only the state of a match (on the queue-browser) while proceeding on the match to construct a chain match. The approach of SQL query flowing across messages would need to construct a view of the entire queue (constructing which is a major overhead) to proceed and match the whole chain in one go.

3. Selectors querying multiple attributes per message and a chain spawning multiple messages would lead to a very complex SQL query/rule prone to errors.

4. The above examples show the regular expression, match as you get style is more performant as compared to a create a table and do a fill match approach.

As another example, consider messages with the following properties:
COLOR=X
NAME=Y
CITY=Z
TOWN=A
COUNTRY=B

There are one million messages on the queue and the messages matching the chain are available at the (123,456) (123,457) (123,458) position in the queue. In order to run the SQL query needs to be a table created of all messages with their individual properties.

| | | | | | COUN- |
|---|---|---|---|---|---|
| | COLOR | NAME | CITY | TOWN | TRY |
| Message#1 | RED | Subject | London | New York | India |
| . | | | | | |
| . | | | | | |
| . | | | | | |
| Message#1000000 | BLUE | Lohit | Delhi | Bangalore | UK |

Construction of this table would mean that browsing on all the one million messages in order to construct this table first and then apply the chain. This is huge overhead as the match may simply fail and one still ends up creating such a huge table.

With the solution provided by the present invention, the chain match starts only at the 123,456 position and ends at 123,458 position.

Proposed SQL query on Table solution

| | |
|---|---|
| M(first) | M{millionth) |
| Step 1: | queue-browser browses through all elements in the queue |
| | and forms a table (needs one whole queue scan) |
| Step 2: | Table created |
| Step 3: | Apply SQL on table |
| Step 4: | Return result set with position in the table marking the |
| | match position |

Solution of an Embodiment of the Present Invention

| | |
|---|---|
| M(first) | M(123,456) M(123,457) |
| M(123,458) | M{millionth) |
| Step 1: | queue-browser continues match from first message |
| Step 2: | queue-browser encounters first match in the chain |
| | at .M(123,456) |
| Step 3: | queue-browser encounters second match in the |
| | chain at .M(123,457) |
| Step 4: | queue-browser encounters full match in the chain |
| | at .M(123,458) |
| Step 5: | queue-browser returns the message set/message |
| Step 6: | queue-browser continues matching |

The only condition when both the database approach and the solution as described in the invention will have equal worst case performance is when the pattern to be matched is at the end of the queue.

Else the solution of the present invention is definitely performant.

Thus, methods, systems, and computer program products for applying selector chaining to message groups in an enterprise computing environment have been described. In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method of selecting one or more of a multitude of messages in an enterprise computing environment, the method comprising:
forming a message-selector chain from a plurality of message selectors, each of the message selectors identifying at least one criteria; and
using said message-selector chain to select one or more of said multitude of messages that satisfy the message selector chain, including:
identifying a first of the multitude of messages that satisfies a first of the message selectors; and
selecting one or more of the multitude of messages that has a defined relationship to said first of the messages and that satisfies a second of the message selectors.

2. The method according to claim 1, further comprising retrieving one or more of the multitude of messages that has a further defined relationship with the message-selector chain.

3. The method according to claim 1, wherein the multitude of messages are arranged in a defined order, and the selecting one or more of the messages includes selecting one or more of the multitude of messages that have a given position in said order relative to the first of the messages.

4. The method according to claim 3, wherein the selecting one or more of the messages includes selecting one or more of the messages that is within a given number of messages of said first of the message in said order.

5. The method according to claim 4, wherein the selecting one or more of the messages includes selecting one or more of the multitude of messages that are next to said first of the messages in said order.

6. The method according to claim 1, wherein the selecting one or more of the multitude of messages includes starting said selecting only after identifying said first of the messages.

7. The method according to claim 1, wherein forming the message-selector chain includes forming the message selector chain with three message selectors; and
using the message selector chain includes identifying a second of the multitude of messages that satisfies a third of the message selectors.

8. The method according to claim 7, wherein the selecting one or more of the multitude of messages includes selecting one or more of the messages that has a defined relationship to the first and second of the messages.

9. The method according to claim 8, wherein the multitude of messages are arranged in a defined order, and the selecting one or more of the multitude of messages includes selecting one or more of the messages that are between the first and the second of the messages in said order.

10. The method according to claim 9, wherein the selecting one or more of the multitude of messages includes selecting all of the messages between the first and the second of the messages in said order and that satisfy the second of the message selectors.

11. A message selecting system for selecting one or more of a multitude of messages in an enterprise computing environment, the message selecting system comprising one or more processor units configured for:
forming a message-selector chain from a plurality of message selectors, each of the message selectors identifying at least one criteria; and
using the message-selector chain to select one or more of said multitude of messages that satisfy the message selector chain, including:
identifying a first of the multitude of messages that satisfies a first of the message selectors, and
selecting one or more of the multitude of messages that has a defined relationship to said first of the messages and that satisfies a second of the message selectors.

12. The message selecting system according to claim 11, wherein the multitude of messages are arranged in a defined order, and the selecting one or more of the messages includes selecting one or more of the multitude of messages that have a given position in said order relative to the first of the messages.

13. The message selecting system according to claim 11, wherein the selecting one or more of the multitude of messages includes starting said selecting only after identifying said first of the messages.

14. The message selecting system according to claim 11, wherein: the forming the message-selector chain includes forming the message selector chain with three message selectors; and the using said message selector chain includes identifying a second of the multitude of messages that satisfies a third of the message selectors.

15. The message selecting system according to claim 14, wherein the multitude of messages are arranged in a defined order, and the selecting one or more of the multitude of messages includes selecting one or more of the messages that are between the first and the second of the messages in said order.

16. An article of manufacture comprising:
at least one computer usable medium having computer readable program code logic to execute a machine instruction in one or more processing units for selecting one or more of a multitude of messages in an enterprise computing environment, the computer readable program code logic, when executing, performing the following:
forming a message-selector chain from a plurality of message selectors, each of the message selectors identifying at least one criteria; and
using said message-selector chain to select one or more of said multitude of messages that satisfy the message selector chain, including:
identifying a first of the multitude of messages that satisfies a first of the message selectors, and
selecting one or more of the multitude of messages that has a defined relationship to said first of the messages and that satisfies a second of the message selectors.

17. The article of manufacture according to claim 16, wherein the multitude of messages are arranged in a defined order, and the selecting one or more of the messages includes selecting one or more of the multitude of messages that have a given position in said order relative to the first of the messages.

18. The article of manufacture according to claim 16, wherein the selecting one or more of the multitude of messages includes starting said selecting only after identifying said first of the messages.

19. The article of manufacture according to claim 16, wherein: the forming the message-selector chain includes forming the message selector chain with three message selectors; and the using said message selector chain includes identifying a second of the multitude of messages that satisfies a third of the message selectors.

20. The article of manufacture according to claim 19, wherein the multitude of messages are arranged in a defined order, and the selecting one or more of the multitude of messages includes selecting one or more of the messages that are between the first and the second of the messages in said order.
